(19) United States
(12) Patent Application Publication
(10) Pub. No.: US 2019/0217811 A1
(43) Pub. Date: Jul. 18, 2019

(54) SEAT BELT HAVING EMBEDDED POCKET FOR STORING CONNECTOR TONGUE

(71) Applicant: Ford Global Technologies, LLC, Dearborn, MI (US)

(72) Inventors: Jose Quezada, Tlalnepantla (MX); Tara Sanzone, Gustavo A. Madero (MX)

(73) Assignee: Ford Global Technologies, LLC, Dearborn, MI (US)

(21) Appl. No.: 15/869,344

(22) Filed: Jan. 12, 2018

(51) Int. Cl. B60R 22/12; B60R 22/18

(52) U.S. Cl. CPC B60R 22/12; B60R 2022/1806; B60R 22/18

(57) ABSTRACT

A vehicle seat belt system is provided. The vehicle seat belt system includes a seat belt strap, a buckle, a connector tongue assembly located on the strap and a pocket embedded on the strap for storing at least a portion of the tongue assembly.

### FIELD OF THE INVENTION

The present invention generally relates to vehicle seat belts, and more particularly relates to the arrangement of a seat belt connector tongue assembly on a seat belt strap.

### BACKGROUND OF THE INVENTION

Automotive vehicles are typically equipped with seat belts for restraining passengers seated in vehicle seats. Conventional seat belts typically include a belt forming a lap belt and a shoulder belt that is connected onto a seat belt tongue which, in turn, releasably connects to a buckle that is fixed to a vehicle structure, such as a seat or a floor. The seat belt is typically made of a seat belt strap in the form of a fabric webbing and the seat belt tongue may slide on the strap to allow repositioning of the tongue between use and non-use positions and to accommodate different size passengers. When the seat belt is disconnected from the buckle in the non-use position, the tongue typically rests on a fixed stop on the strap to maintain the position of the tongue. The tongue is typically a metal tongue that is exposed and may become heated when the sunlight radiates onto it. It would be desirable to provide for a seat belt assembly that may conveniently cover the tongue when not in use.

### SUMMARY OF THE INVENTION

According to one aspect of the present invention, a seat belt system is provided. The seat belt system includes a seat belt strap, a buckle, a connector tongue assembly located on the strap, and a pocket located on the strap for storing at least a portion of the tongue assembly.

Embodiments of the first aspect of the invention can include any one or a combination of the following features:
the pocket is formed of the same material forming the strap;
the pocket is embedded on the strap;
the pocket is stitched onto the outer surface of the strap;
the seat belt strap comprises a webbing material, wherein the pocket is formed of the same webbing material;
the pocket is integrally formed on the strap;
the tongue has a slot for receiving the seat belt strap;
the pocket extends outward from the strap to form a stop position for the tongue assembly;
the tongue assembly comprises a metal tongue;
the pocket stores the metal tongue; and
the tongue assembly is configured to fasten onto the buckle on a seat belt assembly on a vehicle.

According to another aspect of the present invention, a vehicle seat belt system is provided. The vehicle seat belt system includes a seat belt strap, a buckle, a connector tongue assembly located on the strap, and a pocket embedded on the strap for storing at least a portion of the tongue assembly.

Embodiments of the second aspect of the invention can include any one or a combination of the following features:
the pocket is formed of the same material forming the strap;
the pocket is stitched onto the outer surface of the strap;
the seat belt strap comprises a webbing material, wherein the pocket is formed of the same webbing material;
the pocket is integrally formed on the strap;
the tongue has a slot for receiving the seat belt strap;
the pocket extends outward from the strap to form a stop position for the tongue assembly;
the tongue assembly comprises a metal tongue, and wherein the metal tongue is stored in the pocket; and
the tongue assembly is configured to fasten onto the buckle on a seat belt assembly on a vehicle.

These and other aspects, objects, and features of the present invention will be understood and appreciated by those skilled in the art upon studying the following specification, claims, and appended drawings.

### BRIEF DESCRIPTION OF THE DRAWINGS

In the drawings:

FIG. 1 is a perspective view of a passenger cabin of an automotive vehicle having a seat belt system for restraining a passenger and configured with a seat belt tongue assembly and pocket, according to one embodiment;

FIG. 2 is an enlarged view of section II of FIG. 1 further illustrating the seat belt tongue assembly inserted into the pocket in a stored position;

FIG. 3 is an enlarged view of section II of FIG. 1 further illustrating the seat belt tongue assembly in a non-stored position;

FIG. 4 is a front view of the seat belt tongue assembly inserted in the pocket in the stored position; and

FIG. 5 is a cross-sectional view taken through line V-V of FIG. 4 further illustrating the tongue assembly stored in the pocket embedded on the seat belt strap.

### DETAILED DESCRIPTION OF THE PREFERRED EMBODIMENTS

As required, detailed embodiments of the present invention are disclosed herein; however, it is to be understood that the disclosed embodiments are merely exemplary of the invention that may be embodied in various and alternative forms. The figures are not necessarily to a detailed design; some schematics may be exaggerated or minimized to show function overview. Therefore, specific structural and functional details disclosed herein are not to be interpreted as limiting, but merely as a representative basis for teaching one skilled in the art to variously employ the present invention.

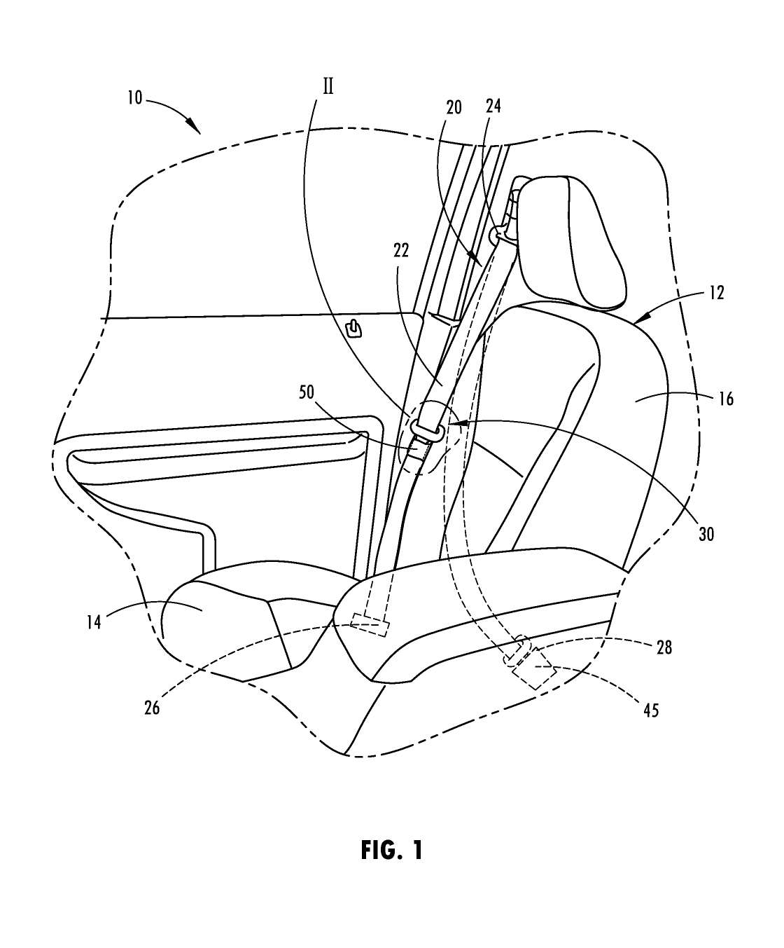

Referring now to FIG. 1, a portion of the passenger cabin or compartment of a vehicle 10 is generally illustrated having a seat belt system 20 assembled onto a seat assembly 12 and including a seat belt connector tongue assembly 30 engaged on a seat belt webbing or strap 22 and stowable in a pocket 50 embedded on the seat belt strap 22, according to one embodiment. The vehicle 10 may include a wheeled motor vehicle, such as a car, truck, van or any other type of vehicle that includes a seat belt system. The seat assembly 12 is generally illustrated including a lower seat 14 pivotally connected to an upper seat back 16 and configured to receive and retain a seated passenger. It should be appreciated that the vehicle 10 may include a plurality of seat assemblies 12 each including a seat belt system 20 having a seat belt tongue assembly 30 engaged on the seat belt strap 22 which has the pocket 50 as shown and described herein.

The seat belt system 20 is shown as a three-point seat belt configuration having the seat belt strap 22 connected at a first connection point 24 generally near the top of the seat back 16 or another supporting portion within the vehicle such as the B-pillar, a second connection point 26 connected to the floor or the seat 14 of the vehicle generally in the region of the lap of a passenger (not shown) seated on the seat 14, and a third connection point 28 shown at a seat belt buckle 45 which releasably connects with the connector tongue assembly 30. The connector tongue assembly 30 is configured to be matingly and releasably coupled to the seat belt buckle 45 for fastening the tongue assembly 30 onto the buckle 45. The seat belt system 20 includes the seat belt comprising the seat belt strap 22 which may be a fabric webbing. The seat belt strap 22 may be flat according to one embodiment or may be generally in the shape of a flattened tube defining an interior passageway which may form a seat belt airbag according to another embodiment.

In the embodiment shown, the seat belt strap 22 serves to form a shoulder belt that is generally positioned to extend from the connector tongue assembly 30 over the shoulder and chest of a passenger and a lap belt which is positioned to extend over the lap of the passenger when seated in the seat assembly 12. The lap belt and shoulder belt are therefore integrally formed of the same strap 22 as shown. It should be appreciated that in the seat belt use position, where the tongue assembly 30 is fastened to the buckle 45, the tongue assembly 30 divides the shoulder belt and the lap belt. The seat belt strap 22 may include a conventional webbing material such as a polyester webbing or nylon webbing that forms a seat belt. The seat belt strap 22 may extend within one or more seat belt retractors such as retractors located at or near one or both of the first connection point 24 and second connection point 26.

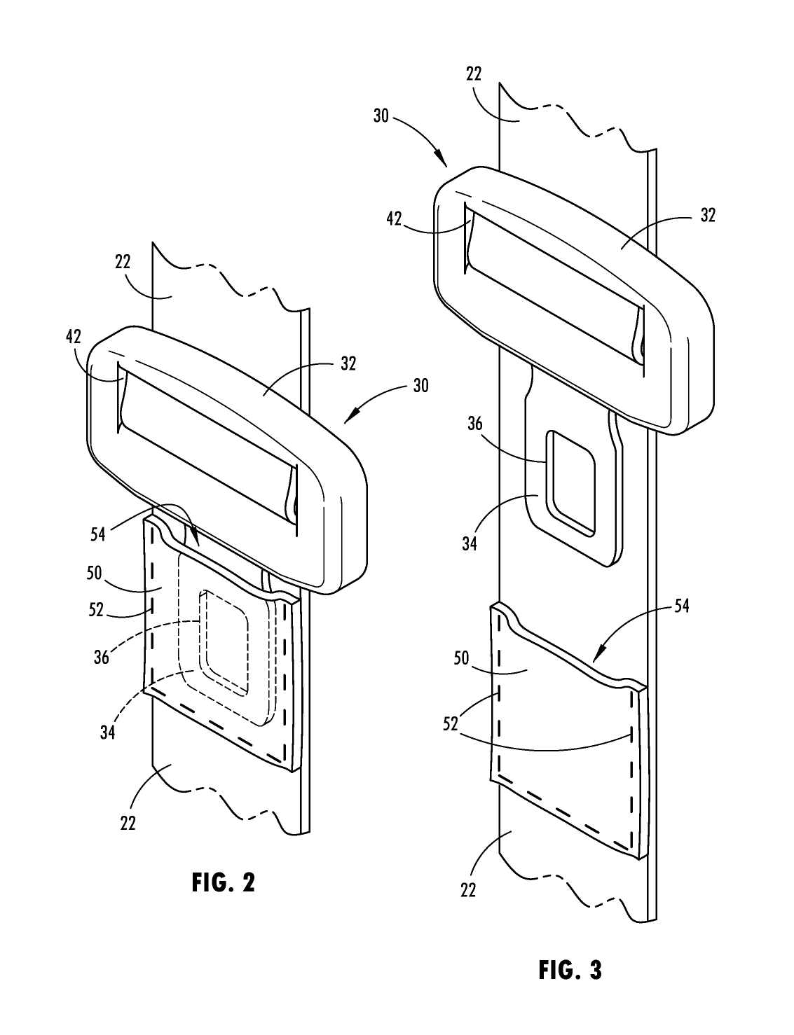

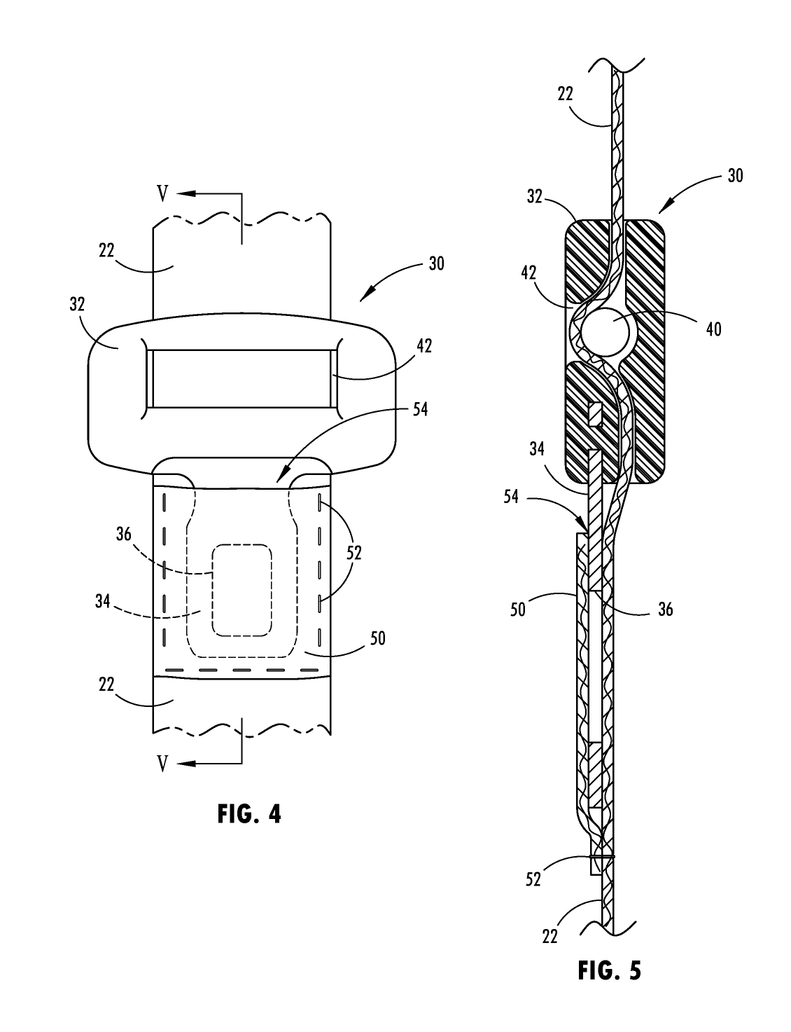

Referring to FIGS. 2-4, the seat belt strap 22 is located on the connector tongue assembly 30 such that the tongue assembly 30 may slide on the seat belt strap 22 and be repositioned. The seat belt strap 22 is positioned to extend through a slot 42 extending through the connector tongue assembly 30 in a conventional manner which enables the seat belt strap 22 to slide within the slot 48 in the seat belt connector tongue assembly 30.

The seat belt connector tongue assembly 30 is further illustrated having a metal tongue 34 that forms a latch plate and has a latch receiving opening 36 to enable engagement and fastening with a latch on the buckle 45. The metal tongue 34 is thus sized and positioned to be received within the buckle 45 and fastened thereto.

The pocket 50 as shown in FIGS. 2-5 is embedded on the seat belt strap 22 and includes an outer sheet of fabric that may be made of the same material as the seat belt strap 22. In one embodiment, the sheet of material forming the pocket 50 may be made of a polyester, such as a woven polyester. According to another embodiment, the sheet of material forming pocket 50 may be made of a nylon and the seat belt strap 22 may be made of a nylon or a polyester material. The pocket 50 is embedded on the seat belt strap 22 so as to form a storage space 54 on one side (e.g., the front side) of the seat belt strap 22 which faces the metal tongue 24 of the connector tongue assembly 30. The pocket 50 is sized to provide a storage opening greater than the size of the metal tongue 34 so as to be able to receive the metal tongue 34 in a position stored within the storage space 54.

The pocket 50 may be made of a separate sheet of material, such as seat belt strap material, which may be stitched or sewn onto the surface of the seat belt strap 22 and thereby embedded on the seat belt strap 22. The stitching connection may include a row of stitching 52 sewn onto the pocket 50 and seat belt strap 22. As such, the stitching 52 extends from a top surface of the pocket 50 through the pocket and to a rear surface of the seat belt strap 22. The stitching 52 may extend along two lateral sides of the pocket 50 and a lower edge of the pocket 50, thereby exposing an open end of the storage space 54 on the upper edge of pocket 50. The storage space 54 is thereby defined by the space between the sheet forming the pocket 50 and the adjoining surface of the seat belt strap 22. The stitching 52 may include a single continuous thread or multiple threads sewn in one or more patterns, such as linear or cross stitch patterns. In one embodiment, the pocket 50 is formed of the same material having the same color and appearance as the seat belt strap 22. As such, the pocket 50 has the same look as the seat belt strap 22 and blends in with the overall seat belt strap 22. It should be appreciated that the pocket 50 may be otherwise formed so as to be embedded on the seat belt strap 22 according to other embodiments. For example, the pocket 50 may be integrally formed on the seat belt strap 22.

While the pocket 50 is shown having a rectangular configuration sized to receive a metal tongue 34 having a generally rectangular shape, it should be appreciated that pocket 50 may be formed in other sizes and configurations. For example, the pocket 50 may be shaped to receive other configurations of connector tongues, such as a tongue configured for a seat belt having an air bag connection formed as part of the connector tongue assembly 30. In doing so, the pocket 50 has a shape and size sufficient to receive the shape and size of at least a portion of or all of the connector tongue assembly 30.

As shown in FIG. 5, the seat belt strap 22 extends through a slot 32 formed in the housing body 32 of the connector tongue assembly 30. The seat belt strap 22 extends and wraps over a portion of a cylindrical bar such as a tube 40 which allows the connector tongue assembly 30 to slide thereon to adjust a position of the connector tongue assembly 30 on the seat belt strap 22. As such, a user may reposition the connector tongue assembly 30 by applying force and sliding it on the seat belt strap 22 to extend across a seated passenger body to fasten the connector tongue assembly 30 onto the buckle 45 and also to reposition the connector tongue assembly 30 on the seat belt strap 22 in a non-use hanging stowed position. Further, the connector tongue assembly 30 may slide along the seat belt strap 22 to move the connector tongue assembly 30 and its metal tongue 34 towards the pocket 50 so as to position at least part of the connector tongue assembly 30 including the metal tongue 34 within the storage space 54 of pocket 50 when not in use. The connector tongue assembly 30 may then be moved out of position from within the storage space 54 by a user when the user uses the seat belt.

The pocket 50 extends outward from the front surface of the seat belt strap 22. The seat belt connector tongue assembly 30 may be configured to engage the outward extending pocket 50 at the entrance of slot 42 which also serves as a stop feature to hold the tongue assembly 30 fixed in position on the seat belt strap 22 sufficient to prevent gravity and normal vehicle use from causing the tongue assembly 30 to slide and thereby change position on the seat belt strap 22. As such, when the seat belt system 20 is in a non-use stowed position, the connector tongue assembly 30 will maintain its position against the pocket 50 suspended on the seat belt strap 22. As such, the seat belt connector tongue assembly 30 does not drop downward towards the ground or slide on the strap 22 during normal vehicle usage, and is maintained in the desired elevated position on the strap 22. When a seated passenger uses the seat belt system 20, the seat belt connector tongue assembly 30 slides along the seat belt strap 22 due to force applied by the user on the connector tongue assembly 30 to enable the tongue assembly 30 to be repositioned and fastened onto the buckle 45.

Accordingly, it should be appreciated that the seat belt system 20 advantageously provides a pocket 50 located on the seat belt strap 22 for storing at least a portion of the connector tongue assembly 30, particularly the metal tongue 34 when not in use. The metal tongue 34 is therefore encased within the storage space 54 and not exposed to direct sunlight or contact with the user such that the metal tongue 34 is protected from heating up due to sunlight. In addition, the pocket 50 advantageously positions and maintains the connector tongue assembly 30 in position on the seat belt strap 22 in a non-use position to thereby necessitate the need for a separate stop feature.

It is to be understood that variations and modifications can be made on the aforementioned structure without departing from the concepts of the present invention, and further it is to be understood that such concepts are intended to be covered by the following claims unless these claims by their language expressly state otherwise.

What is claimed is:

1. A seat belt system comprising:
a seat belt strap;
a buckle;
a connector tongue assembly located on the strap; and
a pocket located on the strap for storing at least a portion of the tongue assembly.

2. The seat belt system of claim 1, wherein the pocket is formed of the same material forming the strap.

3. The seat belt system of claim 1, wherein the pocket is embedded on the strap.

4. The seat belt system of claim 1, wherein the pocket is stitched onto the outer surface of the strap.

5. The seat belt system of claim 1, wherein the seat belt strap comprises a webbing material, wherein the pocket is formed of the same webbing material.

6. The seat belt system of claim 1, wherein the pocket is integrally formed on the strap.

7. The seat belt system of claim 1, wherein the tongue has a slot for receiving the seat belt strap.

8. The seat belt system of claim 7, wherein the pocket extends outward from the strap to form a stop position for the tongue assembly.

9. The seat belt system of claim 1, wherein the tongue assembly comprises a metal tongue.

10. The seat belt system of claim 9, wherein the pocket stores the metal tongue.

11. The seat belt system of claim 1, wherein the tongue assembly is configured to fasten onto the buckle on a seat belt assembly on a vehicle.

12. A vehicle seat belt system comprising:
a seat belt strap;
a buckle;
a connector tongue assembly located on the strap; and
a pocket embedded on the strap for storing at least a portion of the tongue assembly.

13. The seat belt system of claim 12, wherein the pocket is formed of the same material forming the strap.

14. The seat belt system of claim 12, wherein the pocket is stitched onto the outer surface of the strap.

15. The seat belt system of claim 12, wherein the seat belt strap comprises a webbing material, wherein the pocket is formed of the same webbing material.

16. The seat belt system of claim 12, wherein the pocket is integrally formed on the strap.

17. The seat belt system of claim 12, wherein the tongue has a slot for receiving the seat belt strap.

18. The seat belt system of claim 17, wherein the pocket extends outward from the strap to form a stop position for the tongue assembly.

19. The seat belt system of claim 12, wherein the tongue assembly comprises a metal tongue, and wherein the metal tongue is stored in the pocket.

20. The seat belt system of claim 12, wherein the tongue assembly is configured to fasten onto the buckle on a seat belt assembly on a vehicle.
